(19) United States
(12) Patent Application Publication
(10) Pub. No.: US 2002/0118743 A1
(43) Pub. Date: Aug. 29, 2002

(54) Method, apparatus and system for multiple-layer scalable video coding

(76) Inventor: Hong Jiang, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/895,307

(22) Filed: Jun. 29, 2001

Related U.S. Application Data
(60) Provisional application No. 60/272,948, filed on Feb. 28, 2001.

(51) Int. Cl. H04B 1/66; H04N 7/12

(52) U.S. Cl. 375/240.01; 375/240.12

(57) ABSTRACT

A post-clipping method in the coding system for fine granularity scalability (FGS) video coding is applicable to both encoders and decoders. The FGS enhancement layer encoding and decoding operations can be mapped to simple motion compensation operations. Consequently, they can be implemented by using existing data and control paths in the base layer encoder and decoder. The base layer encoder and decoder thus need not be changed. The enhancement encoding and decoding processing is independent of any intermediate data in the base layer as a result of a change in the calculation of the enhancement layer quantization residue. In particular, the quantization residue in the enhancement layer encoder is defined as the difference between the original video data and the reconstructed base layer video data. The enhancement layer encoder thus does not depend upon intermediate base layer data during the coding process. Similar to the encoder, the decoder for the post-clipping addition method also decouples the base layer decoding process and enhancement layer decoding process. The enhancement layer decoding process can be mapped into a simple motion compensation case using the base layer picture as reference

### REFERENCE TO RELATED APPLICATION

This application claims the benefit of U.S. Provisional Application No. 60/272,948, filed Feb. 28, 2001.

### BACKGROUND

1. Field

The invention relates generally to video processing and, more particularly to, a method, apparatus and system for video coding.

2. Background Information

Video is principally a series of still pictures, one shown after another in rapid succession, to give a viewer an illusion of motion. In many computer-based and network-based applications, video plays important roles. Before it can be transmitted over a communication channel, video may need to be converted, or “encoded,” into a digital form. In digital form, the video data is made up of a series of bits called a “bitstream.” Once encoded as a bitstream, video data may be transmitted along a digital communication channel. When the bitstream arrives at the receiving location, the video data are “decoded,” that is, converted back to a form in which the video may be viewed. Due to bandwidth constraints of communication channels, video data are often “compressed” prior to the transmission on a communication channel. Compression may result in a loss of picture quality at the receiving end.

A compression technique that partially compensates for loss of quality involves separating the video data into two bodies of data prior to transmission: a “base layer” and one or more “enhancement layers.” The base layer includes a rough version of the video sequence and may be transmitted using comparatively little bandwidth. Each enhancement layer also requires little bandwidth, and one or more enhancement layers may be transmitted at the same time as the base layer. At the receiving end, the base layer may be recombined with the enhancement layers during the decoding process. The enhancement layers provide correction to the base layer, consequently improving the quality of the output video. Transmitting more enhancement layers produces better output video, but requires more bandwidth. Enhancement layers may contain information to enhance the color of a region of a picture and to enhance the detail of the region of a picture.

In addition to coding efficiency, simplicity of implementation is an important criterion for evaluating a video coding algorithm. This includes the implementations of both encoder and decoder. Among the two, decoder complexity is the most important factor, since the proliferation of any video coding technique can only happen when it is possible to mass produce low-cost consumer electronics devices. For example, the success of MPEG-2 is partly due to the availability of low-cost decoder hardware. (MPEG is short for Motion Picture Experts Group, and MPEG-2 and MPEG-4 represent digital video compression standards and file formats developed by the group.) A low complexity encoder is also desired in interactive application areas such as video conferencing where symmetrical encoding and decoding operations are utilized.

MPEG-4, a recently developed image/video compression technique, is capable of encoding semantically different visual objects separately. The MPEG-4 video compression standard is described in ISO document ISO/IEC JTC1/SC29/WG11 N2201 (May 15, 1998), the disclosure of which is incorporated by reference herein. According to MPEG-4, encoders identify “video objects” from a scene to be coded. Individual frames of the video object are coded as “video object planes” or VOPs. The spatial area of each VOP is organized into blocks or macroblocks of data, which typically are 8 pixel by 8 pixel (blocks) or 16 pixel by 16 pixel (macroblocks) rectangular areas. A macroblock typically is a grouping of four luminous blocks and two chrominous blocks. For simplicity, reference herein is made to blocks but it should be understood that such discussion applies equally to macroblocks and macroblock based coding. Image data of the blocks are coded by an encoder, transmitted through a channel and decoded by a decoder.

In particular, the scalable video coding technique called fine granularity scalability (FGS) coding as described in ISO drafted document ISO/IEC JTC1/SC29/WG11 N3095 (Dec., 1999), relies on the use of bit-plane variable length coding (“VLC”) for the quantization residual data of a base layer MPEG-4 video. Referring to FIG. 1, a simplified conventional FGS encoder 10 is illustrated. In the quantization/dequantization method for the base layer 12, the quantization parameter may be defined as follows:

QP[n]=Q[n]*quant_scale (Eq. 1)

where

n=DCT coefficient location within a block, which takes values from 0 to 63 in a given DCT scanning order with a fixed block size of 8×8

QP[n]=quantization parameter

Q[n]=quantization matrix element

quant_scale =quantizer scale factor for a given macroblock

The base layer quantization (Eq. 2) and dequantization (Eq. 3) may be defined as follows:

qcoeff[n]=SIGN(coeff[n])*((ABS(coeff[n])−QP[n]/2)/(2*QP[n])) (Eq. 2)

rcoeff[n]=SIGN(qcoeff[n])*(ABS(coeff[n])*2*QP[n]+QP[n]+(QP[n]/2)−1) (Eq. 3)

where

[n]=variables with index of [n] are for one DCT coefficient location and variables without an index are a constant at least for a block or a macroblock

coeff [n]=original DCT coefficient

qcoeffl[n]=quantized DCT coefficient

rcoeff[n]=reconstructed base layer DCT coefficient

ABS( )=absolute value operation

SIGN( )=sign operation

For a given base layer quantizer, the residue of DCT coefficients due to quantization may be defined as follows:

residue[n]=coeff[n]−rcoeff[n] (Eq. 4)

The above residue values are not directly coded as enhancement data. Instead, they are modified by the frequency weighting and spatial selective enhancement functions. The weighted residue used by a conventional FGS method may be defined as follows:

wresidue[n]=SIGN(residue[n])*(ABS(residue[n])/(W[n]*residue_{—}scale)) (Eq. 5)

where

W[n]=frequency weighting matrix

residue_scale=spatial scale factor for the macroblock

The magnitude (Eq. 6]) and the sign (Eq. 7) of the weighted residue may be defined as follows

diff[n]=ABS(wresidue[n]) (Eq. 6)

sign[n]=SIGN(wresidue[n]) (Eq. 7)

After diff[n] and sign[n] are calculated, the maximum and minimum values of diff[n] determine the total number of bit-planes to be encoded. Bit-plane enhancement layer encoding 14 is ordered sequentially starting from the most significant bit plane.

In the conventional simplified encoder shown in FIG. 1, the bit-plane shift unit applies operation on the residue values using Eq. 5. The enhancement layer encoder 14 differs from a base-layer encoder 12 by introducing a residual calculator and a separate encoding pipe. The residual calculation thus relies on intermediate data 18 from the base layer encoder 12. However, the change of encoder structure is typically minimal, since both the original DCT coefficient (coeff[n]) and reconstructed base layer DCT coefficient (rcoeff[n]) already exist in the base layer process 12.

Referring to FIG. 2, a conventional simplified FGS decoder 20 is illustrated. The FGS enhancement layer decoding process 22 is the reverse of the above-described enhancement layer encoding process 14. Since the restoration of DCT coefficients for the enhancement layer 22 requires access to the DCT coefficients in the base layer encoder 24, as denoted by path “A”, the decoding process of both the enhancement layer decoder 22 and base layer decoder 24 is coupled. In other words, intermediate data 26 in the base layer decoder 24 needs to be stored or the enhancement and base layer decoding processes must run concurrently in order to share data. These restrictions also apply to other forms of intermediate data 26, such as motion prediction results. As denoted by path “B”, the enhancement layer decoder 22 needs to access the base layer motion prediction results to form the final enhancement reconstruction. The resultant cross-coupling between the enhancement and base layers introduce encoder and decoder design complexity.

What is needed therefore is a simplified FGS encoder and decoder that is not dependent on intermediate data in the base layer and eliminates cross-coupling between the enhancement layer and the base layer.

### BRIEF DESCRIPTION OF THE DRAWINGS

FIG. 1 is a block diagram of a conventional FGS encoder structure.

FIG. 2 is a block diagram of a conventional FGS decoder structure.

FIG. 3 is a block functional block diagram showing a path of a video signal in accordance with an embodiment of the present invention.

FIG. 4 is block diagram of an encoder structure in accordance with an embodiment of the present invention.

FIG. 5 is a block diagram of a decoder structure in accordance with an embodiment of the present invention.

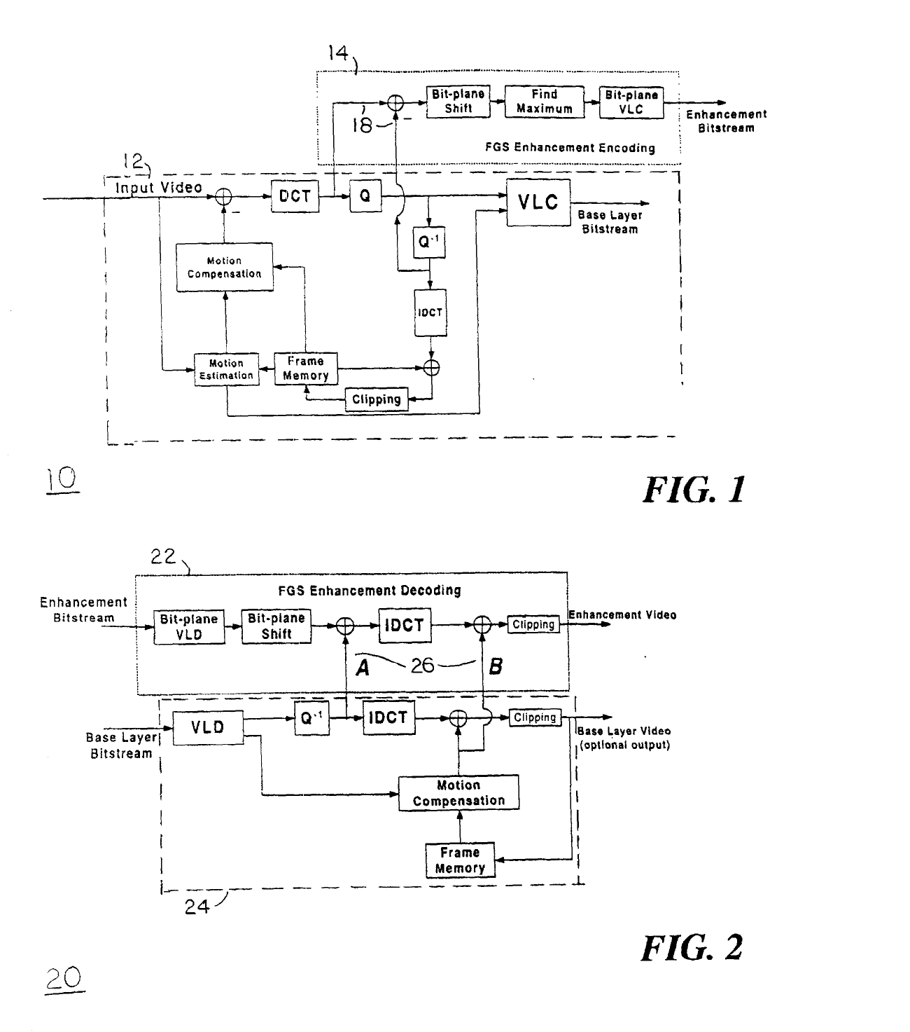

### DETAILED DESCRIPTION

Embodiments of the present invention provide a post-clipping method in the coding system for fine granularity scalability (FGS) video coding and is applicable to both encoders and decoders. The fine granularity scalability (FGS) enhancement layer encoding and decoding operations can be mapped to simple motion compensation operations. Consequently, they can be implemented by using existing data and control paths in the base layer encoder and decoder. The base layer encoder and decoder thus need not be changed. The post-clipping method and apparatus for improving enhancement layer video coding results in simplicity in multiple-layer video coding. Additionally, it also allows the FGS video coding to be extended with spatial scalability. The enhancement encoding and decoding processing is independent of any intermediate data in the base layer 30 as a result of a change in the calculation of the enhancement layer quantization residue as described in detail below.

In the detailed description, numerous specific details are set forth in order to provide a thorough understanding of the present invention. However, it will be understood by those skilled in the art that the present invention may be practiced without these specific details. In other instances, well-known methods, procedures, components and circuits have been described in detail so as not to obscure the present invention.

Some portions of the detailed description that follow are presented in terms of algorithms and symbolic representations of operations on data bits or binary signals within a computer. These algorithmic descriptions and representations are the means used by those skilled in the data processing arts to convey the substance of their work to others skilled in the art. An algorithm is here, and generally, considered to be a self-consistent sequence of steps leading to a desired result. The steps include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Unless specifically stated otherwise as apparent from the following discussions, it is appreciated that throughout the specification, discussions utilizing such terms as “processing” or “computing” or “calculating” or “determining” or the like, refer to the action and processes of a computer or computing system, or similar electronic computing device, that manipulate and transform data represented as physical (electronic) quantities within the computing system's registers and/or memories into other data similarly represented as physical quantities within the computing system's memories, registers or other such information storage, transmission or display devices.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

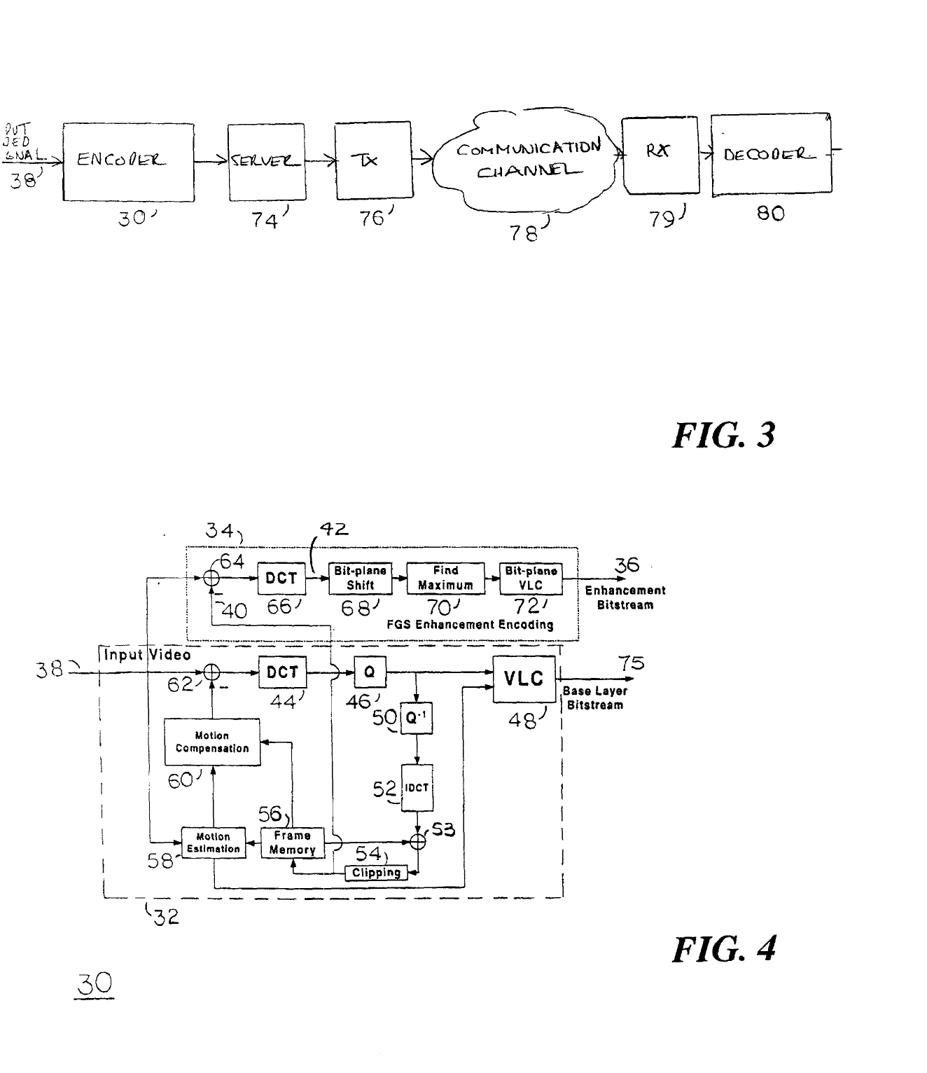

Referring to FIG. 3, a block diagram showing one embodiment of a general path taken by video data being distributed over a network is illustrated. The input video signal 38 is fed into an encoder 30, which converts the signal 38 into video data, in the form of a machine-readable series of bits, or bitstream 75 and 36. The video data are then stored on a server 74, pending a request for the video data. When the server 74 receives a request for the video data, it sends the data to a transmitter 76, which transmits the data along a communication channel 78 on the network. A receiver 79 receives the data and sends the data as a bitstream to a decoder 80. The decoder 80 converts the received bitstream into an output video signal, which may then be viewed.

The encoding done in the encoder 30 may involve lossy compression techniques such as MPEG-4, version 1 or version 2, resulting in a base layer bitstream 75, that is, a body of data sufficient to permit generation of a viewable video sequence of lesser quality than is rep resented by the source video sequence. The base layer bitstream 75 comprises a low-bandwidth version of the video sequence. If it were to be decoded and viewed, the base layer bitstream 75 would be perceived as an inferior version of the original video 38. The base layer bitstream 75 comprises a low-bandwidth version of the video sequence. One compression technique called motion compensation employed by MPEG is to encode most of the pictures in the video sequence as changes from one picture to one or more reference pictures of the picture, rather than as the picture data itself. The reference pictures for a picture are the past or future pictures temporally close to the current picture. This technique results in a considerable saving of bandwidth.

FIG. 4 is a block diagram of a FGS encoder 30 including a base layer encoder 32 and enhancement layer encoder 34 in accordance with one embodiment of the present invention. As discussed in detail below, when the encoder 30 is used to code a sequence of video object plane (VOP), the encoder 30 produces base layer bitstream 75 and enhancement bitstreams 36. The input video sequence 38 is used to create/converted to base layer and enhancement bitstreams 75 and 36. The base layer bitstream 75 is generated based upon sampling the input video sequence 38. The enhancement layer bitstream 36 is generated based upon sampling the input video sequence 38 and the reconstructed base layer video data 40 (reconstructed from base layer bitstream and after clipping operation 54).

In particular, the quantization residue 42 in the enhancement layer encoder is defined as the difference between the original video data 38 and the reconstructed base layer video data 40. The enhancement layer encoder 34 thus does not depend upon intermediate base layer data during the coding process. Since the enhancement encoding process only utilizes the original and reconstructed base layer data, 38 and 40, it can be performed independently from the base layer encoder 32 as long as the reconstructed base layer video data 40 is available.

In particular, the quantization residues 42 are defined as the DCT coefficients of the difference between the original video data 38 and the reconstructed base layer video data 40:

residue[n]=DCTₙ(Block_{orig}−Block_{base}) (Eq. 8)

where Block_{orig} and Block_{base} denote the spatial values for the same block in the original video data and reconstructed base layer video data, 38 and 40 respectively, DCT, denotes the nth coefficient of the enhancement layer DCT transform 66. Let Block_{pred} denote the base layer motion prediction results for the block, Block_{orig} and Block_{base} may be further defined according to the following equations:

Block_{orig}=Block_{pred}+IDCT(coeff) (Eq. 9)

Block_{base}=CLIP(Block_{pred}+IDCT(rcoeff)) (Eq. 10)

where CLIP( ) is the non-linear clipping function that constrains the output to a designated data range. When the spatial values of the reconstructed video data are constrained to 8-bit digital representation, the non-linear clipping function CLIP( ) is usually defined as the follows:

CLIP(x)=0 if x<0

=255 else if x>255

=x elsewise (Eq. 11)

Therefore, the quantization residue 42 defined in Eq. 8 can be rewritten as follows:

residue[n]=DCTₙ(Block_{pred})+coeff[n]−DCTₙ(CLIP(Block_{pred}+IDCT(roeff))) (Eq. 12)

The calculation of the quantization residue 42 of the present invention takes into account a non-linear clipping operation.

Referring to FIG. 4, in one embodiment of operation, the original input video data 38 or the changes from one picture to one or more reference pictures of the picture as the output from the subtraction 62 are applied to a transform, such as a DCT 44 to reduce the redundancy in the two dimensional spatial domain. The DCT is a linear transform similar to the discrete Fourier transform in that the transformed data are ordered by frequency and are weighted by coefficients. An 8-by-8 block of pixels undergoing a DCT will generate an 8-by-8 matrix (block) of coefficients. The DCT may operate on groups of pixels of other sizes as well, such as a 16-by-16 block, an 8-by-16 block, or a 16-by-8 block, but the transform of an 8-by-8 block is an exemplary application of the DCT.

When a compression technique is combined with a DCT algorithm, the DCT transform is usually performed after input data is sampled in a unit size of 8 by 8, and the transform coefficients are quantized (Q) 46 with respect to a visual property using quantization paramenter QP[n] as defined in Eq. 1. Then, the data is compressed through a lossless coder, such as a variable length coder (VLC) 48. The data processed with the DCT 44 is converted from a spatial domain to a frequency domain and lossly compressed through the quantizer 46. The quantized data in a block can be scanned (not shown) according a scan order into a sequence of quantized data. The sequence of quantized data can be represented by a sequence of symbols. A run-level symbol is defined, according to MPEG standards, as a value (‘level’) of a non-zero coefficient and the number (‘run’) of the preceding zero coefficients. A symbol having a relatively high statistical frequency is commonly coded with a short code word via the VLC 48. A symbol having a low statistical frequency is commonly coded with a long code word. Thus, the data is finally compressed.

Quantized DCT coefficients are also inverse quantized (Q⁻¹) 50, inverse discrete cosine transformed (IDCT) 52 and motion compensated 53 to provide past video data to the motion estimation unit 58 concurrently with present video data. The motion estimation unit uses the past and present video data, which may be stored in the frame memory, to generate motion vectors that are variable length encoded 48 and multiplexed with the compressed DCT coefficients. In particular, the portion of the encoder for encoding the changes between individual pictures includes inverse quantization 50, inverse discrete cosine transform 52, clipping 54, frame memory 56, motion estimation 58, motion compensation 60, subtraction 62 of the reference picture(s) from the input picture stream to isolate the changes from one picture to its reference picture(s), discrete cosine transform 44, quantization 46, and variable length coder 48. The base layer bitstream 75 thus includes conventional motion compensated transform encoded texture and motion vector data.

Other bodies of data, called enhancement layers, may capture the difference between a quantized base video data and an original (unquantized) input video data. Enhancement layers enhance the quality of the viewable video sequence generated from the base layer. Combining the base layer with a single enhancement layer at the receiving end will result in a video output of quality closer to the original input video. Combining an additional enhancement layer provides additional correction and additional improvement. Combining the base layer with all enhancement layers at the receiving end will result in a video output of quality nearly equal to the original input video.

An enhancement layer corresponding to a picture may contain a correction to the change from one picture to its reference picture(s), or it may contain a correction to the picture data itself. An enhancement layer generally corresponds to a base layer. If a picture in the base layer is encoded as changes from one picture to its reference picture(s), then the enhancement layers corresponding to that picture generally contain a correction to the change from one picture to its reference picture(s). A picture in an enhancement layer may not have a corresponding picture in the base layer. In this case, the quantization residue 42 is in fact equal to the original input video data or the change form one picture to its reference picture(s).

In accordance with one embodiment of the present invention, the enhancement layer bitstream 36 is generated based upon sampling the input video sequence 38 and the reconstructed base layer video data 40 (reconstructed from base layer bitstream and post clipping operation 54). In particular, the quantization residue 42 in the enhancement layer encoder is defined as the discrete cosine transform of the difference between the original video data 38 and the reconstructed base layer video data 40.

As shown in the embodiment in FIG. 4, a subtraction 64 results in the creation of enhancement layers, which are also called “quantization residue”, “residue” or “residual data.” The enhancement layers contain the various bits of the difference between the original video data 38 and the reconstructed base layer video data 40. The enhancement layers corresponding to each picture represent enhancements to the changes between individual pictures, as well as enhancements to the individual pictures themselves. The output of the subtraction operation 64 is applied to a DCT 66, the output of which undergoes a residue shift process via the bit-plane shift 68 to emphasize the visually important components in the enhancement layer and de-emphasize the visually insignificant components. One skilled in the art will recognize that there are many ways to accomplish this result.

After processing the enhancement data through a residue shifter (bit-plane shift) 68, it may be necessary to find which bits of the residue shifted data are most significant. A processor 70 to find the new maximum may perform this function, and may arrange the enhancement layer data into individual enhancement layers, or “bit planes,” the first bit plane containing the most significant bits of enhancement data, the second bit plane containing the next most significant bits of enhancement data, and so on. The bit planes may then be processed into an enhancement layer bitstream by a bit-plane variable length coder (Bit-plane VLC) 72.

FIG. 4 demonstrates encoding and compression of a series of input pictures, resulting in a base layer bitstream 75 of the video data plus a bitstream 36 of one or more enhancement layers according to one embodiment of the invention. The residue-generation operations in the enhancement process that are performed by the enhancement layer encoder 34 in accordance with the present invention are (a) subtraction 64 of original video data 38 and the reconstructed base layer data 40 and (b) a discrete cosine transform (DCT) 66. However, the residue-generation operations in the enhancement layer encoder 34 may be treated as a degenerated case of motion estimation and motion compensation of the base layer encoder 32, where motion vectors are fixed as (0,0) and the reconstructed base layer data 40 serves as the reference picture. As shown above, the enhancement encoding process is independent of any intermediate data in the base layer 32. Since the enhancement encoding process only utilizes the original and reconstructed base layer data 38 and 40, it can be performed independently from the base layer encoder 32. Therefore, some circuitry of the base layer encoder 32 can be reused for the enhancement layer encoder 34. The base layer bitstream 75 and enhanced layer bitstream 36 may be combined into a single output bitstream (not shown) by a multiplexer (not shown), prior to storage on a server or transmission along a communication channel.

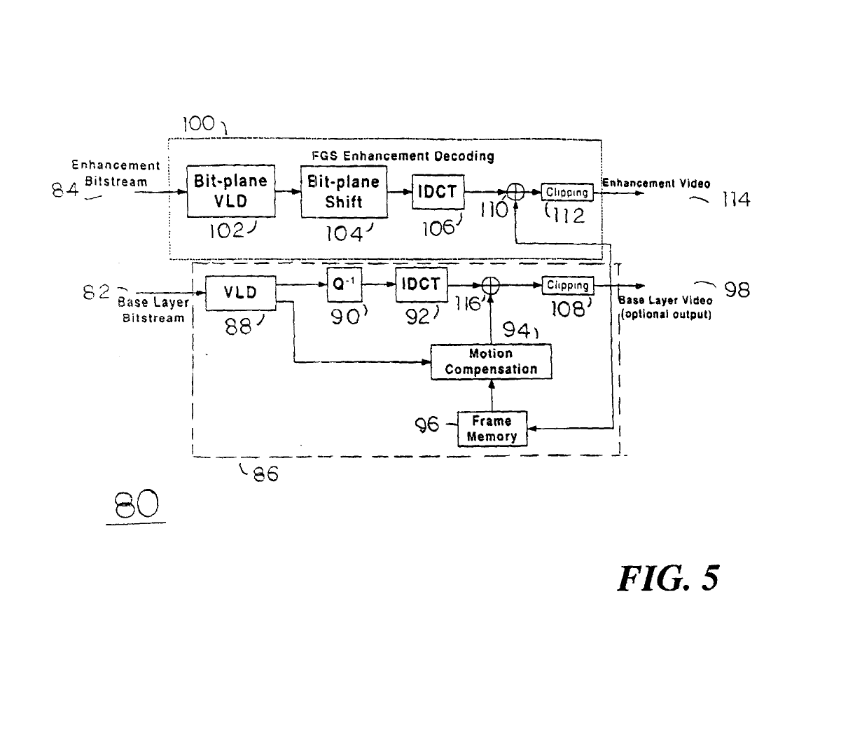

The present invention provides a post-clipping method in the coding system for fine granularity scalability (FGS) video coding and is applicable to decoders as well. The fine granularity scalability (FGS) enhancement layer decoding operation can be mapped to simple motion compensation operations. Consequently, they can be implemented by using existing data and control paths in the base layer decoder. The base layer decoder thus needs not be changed. Referring to FIG. 5, in one embodiment, the enhancement layer decoder 100 is independent of any intermediate data in the base layer decoder 86 as a result of a change in the calculation of the enhancement layer residue. In particular, the enhancement residual addition applies to the final base layer output after the base layer clipping operation. Therefore, it is referred to as a post-clipping addition method, or simply a post-clipping method. Similar to the encoder 30 shown in FIG. 4, the decoder for the post-clipping addition method also decouples the base layer decoding process and enhancement layer decoding process. In fact, the enhancement layer decoding process can be mapped into a simple motion compensation case using the base layer picture as reference. The enhancement layer decoder thus does not depend upon intermediate base layer data during the decoding process.

FIG. 5 demonstrates one embodiment of a method for decoding and recovery of video data that has been transmitted by a server over a communication channel and received by a client. At the receiving end, the input to the decoder 80 includes a bitstream of video data (not shown) which may be separated into a bitstream of base layer data 82 and a bitstream of enhancement layer data 84. A demultiplexer (not shown) may be used to separate the bistreams 82 and 84. The base layer bitstream 82 and the enhancement layer bitstream(s)84 may be subjected to different decoding processes, or “pipelines”. Just as the encoding of base and enhancement layers may not have involved identical steps, there may be some differences in the decoding processes as well.

In the base layer decoding pipeline 86, the base layer bitstream 82 may undergo a variable length decoding (VLD) 88, an inverse quantization (Q⁻¹) 90 and an IDCT 92. The variable length decoding 88, inverse quantization 90 and IDCT 92 operations essentially undo the variable length coding 48, quantization 46 and DCT 44 operations performed during encoding shown in FIG. 4. The output from the IDCT is then applied to the adder 116 and then clipped 108 to become the reconstructed base layer video data 98. In accordance with the present invention, the enhancement residual addition applies to the final base layer output after the base layer clipping operation. Similar to the embodiment of the encoder 30 shown in FIG. 4, the decoder for the post-clipping addition method also decouples the base layer decoding process and enhancement layer decoding process.

Decoded base layer data may then be processed in a motion compensator 94, which may reconstruct individual pictures based upon the changes from one picture to its reference picture(s). Data from the reference picture(s), a previous one or a future one or both, may be stored in a temporary frame memory 96 such as a frame buffer and may be used as the references. The motion compensator 94 uses the motion vectors decoded from the VLD 88 to determine how the current picture in the sequence changes from the reference picture(s). The output of the motion compensator 94 is the motion prediction data. The motion prediction data is added to the output of the IDCT 92 by the adder 116. The output from the adder 116 is then clipped 108 to become the reconstructed base layer video data 98. The output of the base layer pipeline 86 is base layer video data 98. The decoding techniques shown in FIG. 5 are illustrative but are not the only way to achieve decoding.

The decoding pipeline for enhancement layers 100 is different from the decoding pipeline for the base layer 86. Following a bit-plane variable length decoding process (Bit-plane VLD) 102, the enhancement layer data undergoes a bit-plane shift process 104 that undoes the residue shift. Without residue adjustment, the enhancement layers will overcorrect the base layer. The output is then applied to the inverse discrete cosine transform (IDCT) 106.

The enhancement layer data from the IDCT 106 may be summed 110 with the output from the base layer clipping operation 108. The output from the IDCT 106 represents a correction. The output from the summing operation 110 is then clipped 112 and the resultant output represents the enhanced layer of video data 114.

When the enhanced layer of video undergoes recombination (as shown by the adder 110) with the base layer, the result may be a picture in the video sequence ready for viewing. Typically pictures ready for viewing are stored in the frame buffer, which can provide a steady stream of video picture data to a viewer (not shown).

FIG. 5 demonstrates one embodiment of the decoding and reconstruction of sequences of base layer bitstream and enhancement layer bitstreams, resulting in a stream of viewable video pictures. The residue-combination operation in the enhancement decoding process that is performed by the enhancement layer decoder 100 in accordance with the present invention is the addition 110 of enhancement residue IDCT 106 output and the reconstructed base layer data post clipping. However, the residue-combination operation in the enhancement layer decoder 100 may be treated as a degenerated case of motion compensation of the base layer decoder 86, where motion vectors are fixed as (0,0) and the reconstructed base layer data 40 serves as the reference picture. As shown above, the enhancement decoding process is independent of any intermediate data in the base layer 86, therefore, it can be performed independently from the base layer decoder 86. Therefore, some circuitry of the base layer decoder 86 can be reused for the enhancement layer decoder 100.

The post-clipping addition method simplifies both the encoder and decoder. Most noticeably, the base layer encoder and decoder need not be changed. One skilled in the art will recognize that the encoder 30 and decoder 80 shown in FIGS. 4 and 5 are exemplary embodiments. Some of the operations depicted in FIGS. 4 and 5 are linear, and may appear in a different order. In addition, encoding and decoding may consist of additional operations that do not appear in FIGS. 4 and 5.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A method comprising:
generating data associated with a source video sequence, at least a first body of data being sufficient to permit generation of a first viewable video sequence of lesser quality than is represented by the source video sequence; and
generating at least a second body of data, dependent upon the source video sequence and a reconstructed portion of the first body of data, being sufficient to enhance the quality of the first viewable video sequence generated by the first body of data.

2. The method of claim 1, wherein generating at least a second body of data, dependent upon the source video sequence and a reconstructed portion of the first body of data, being sufficient to enhance the quality of the first viewable video sequence generated by the first body of data further comprises:
reusing circuitry associated with generating the at least first body of data for generating the at least second body of data.

3. The method of claim 1, wherein the units of the second bodies of data include a block of video data.

4. The method of claim 1, wherein the reconstructed portion of the first body of data includes data that has been clipped.

5. The method of claim 1, wherein generating at least a second body of data, dependent upon the source video sequence and a reconstructed portion of the first body of data, being sufficient to enhance the quality of the first viewable video sequence generated by the first body of data further comprises:
determining the difference between the source video sequence and reconstructed portion of the first body of data.

6. An article comprising a computer-readable medium which stores computer-executable instructions, the instructions causing a computer to:
generate data associated with a source video sequence, at least a first body of data being sufficient to permit generation of a first viewable video sequence of lesser quality than is represented by the source video sequence; and
generate at least a second body of data, dependent upon the source video sequence and a reconstructed portion of the first body of data, being sufficient to enhance the quality of the first viewable video sequence generated by the first body of data.

7. The article of claim 6, wherein instructions causing the computer to generate at least a second body of data, dependent upon the source video sequence and a reconstructed portion of the first body of data, being sufficient to enhance the quality of the first viewable video sequence generated by the first body of data further comprises:
instructions causing the computer to reuse circuitry associated with generating the at least first body of data for generating the at least second body of data.

8. The article of claim 6, wherein the units of the second bodies of data include a block of video data.

9. The article of claim 6, wherein the reconstructed portion of the first body of data includes data that has been clipped.

10. The article of claim 6, wherein the instructions causing the computer to generate at least a second body of data, dependent upon the source video sequence and a reconstructed portion of the first body of data, being sufficient to enhance the quality of the first viewable video sequence generated by the first body of data further comprises:
instructions causing the computer to determine the difference between the source video sequence and reconstructed portion of the first body of data.

11. A method for encoding a video sequence of pictures, comprising:
applying encoding to the sequence of pictures to produce a first body of data being sufficient to permit generation of a viewable video sequence of lesser quality than is represented by the source video sequence; and
deriving a second body of data, based upon the video sequence of pictures and a reconstructed portion of the first body of data, sufficient to enhance the quality of the viewable video sequence generated from the first body of data.

12. The method of claim 11, wherein deriving a second body of data based upon the video sequence of pictures and a reconstructed portion of the first body of data, sufficient to enhance the quality of the viewable video sequence generated from the first body of data, further comprises:
reusing circuitry associated with generating the first body of data for generating the second body of data.

13. The method of claim 11, further comprising determining the difference between the video sequence of pictures and a reconstructed portion of the first body of data.

14. The method of claim 11, wherein the units of the second bodies of data include a block of video data.

15. The method of claim 11, wherein the reconstructed portion of the first body of data includes data that has been clipped.

16. An article comprising a computer-readable medium which stores computer-executable instructions for encoding a video sequence of pictures, the instructions causing a computer to:
apply encoding to the sequence of pictures to produce a first body of data being sufficient to permit generation of a viewable video sequence of lesser quality than is represented by the source video sequence; and
derive a second body of data, based upon the video sequence of pictures and a reconstructed portion of the first body of data, sufficient to enhance the quality of the viewable video sequence generated from the first body of data.

17. The article of claim 16, wherein instructions for causing the computer to derive a second body of data based upon the video sequence of pictures and a reconstructed portion of the first body of data, sufficient to enhance the quality of the viewable video sequence generated from the first body of data, further comprises:
instructions for causing the computer to reuse circuitry associated with generating the first body of data for generating the second body of data.

18. The article of claim 16, further comprising instructions for causing the computer to determine the difference between the video sequence of pictures and a reconstructed portion of the first body of data.

19. The article of claim 16, wherein the units of the second bodies of data include a block of video data.

20. The article of claim 16, wherein the reconstructed portion of the first body of data includes data that has been clipped.

21. A system for encoding and decoding a video sequence of pictures, comprising:
an encoder capable of
generating data associated with a source video sequence, at least a first body of data being sufficient to permit generation of a first view able video sequence of lesser quality than is represented by the source video sequence;
generating at least a second body of data, dependent upon the source video sequence and a reconstructed portion of the first body of data, being sufficient to enhance the quality of the first viewable video sequence generated by the first body of data;
a decoder capable of
undoing the adjustment made by the encoder.

22. The system of claim 21, wherein an encoder capable of generating at least a second body of data, dependent upon the source video sequence and a reconstructed portion of the first body of data, being sufficient to enhance the quality of the first viewable video sequence generated by the first body of data further comprises an encoder capable of:
causing the computer to reuse circuitry associated with generating the at least first body of data for generating the at least second body of data.

23. The system of claim 21 wherein the decoder is further capable of
performing decoding operations on the first and second bodies of data.

24. The system of claim 23, further comprising a decoder capable of:
causing the computer to reuse circuitry associated with decoding the at least first body of data for decoding the at least second body of data.

25. The system of claim 23, wherein the decoder is further capable of
combining the first body with the second body of data.

26. The system of claim 23, wherein post-clipped data from the first body of data is combined with the second body of data.

27. A system for encoding and decoding a video sequence of pictures, comprising:
an encoder capable of
generating at least a first body of data;
generating at least a second body of data, dependent upon the video sequence and a reconstructed portion of the first body of data; and
causing the computer to reuse circuitry associated with generating the at least first body of data for generating the at least second body of data;
a decoder capable of
performing decoding operations on the first and second bodies of data; and
causing the computer to reuse circuitry associated with generating the at least first body of data for generating the at least second body of data.

28. The system of claim 27, wherein the decoder is further capable of combining the first body with the second body of data.

29. The system of claim 27, wherein post-clipped data from the first body of data is combined with the second body of data.

30. A method for encoding and decoding a video sequence of pictures, comprising:
generating data associated with a source video sequence, at least a first body of data being sufficient to permit generation of a first viewable video sequence of lesser quality than is represented by the source video sequence;
generating at least a second body of data, dependent upon the source video sequence and a reconstructed portion of the first body of data, being sufficient to enhance the quality of the first viewable video sequence generated by the first body of data; and
decoding the at least the first and second body of data.

31. The method of claim 30, wherein generating at least a second body of data, dependent upon the source video sequence and a reconstructed portion of the first body of data, being sufficient to enhance the quality of the first viewable video sequence generated by the first body of data further comprises:
reusing circuitry associated with generating the at least first body of data for generating the at least second body of data.

32. The method of claim 30, further comprising:
reusing circuitry associated with decoding the at least first body of data for decoding the at least second body of data.

33. The method of claim 30, further comprising:
combining the first and second bodies of decoded data.

34. The method of claim 30, wherein post-clipped data from the first body of data is combined with the second body of data.

35. A method for encoding and decoding a video sequence of pictures, comprising:
generating at least a first body of data;
generating at least a second body of data, dependent upon the video sequence and a reconstructed portion of the first body of data;
reusing circuitry associated with generating the at least first body of data for generating the at least second body of data;
performing decoding operations on the first and second bodies of data; and
reusing circuitry associated with decoding the at least first body of data for decoding the at least second body of data.

36. The method of claim 35, further comprising combining the first body with the second body of decoded data.

37. The method of claim 35, wherein post-clipped data from the first body of data is combined with the second body of data.

38. A method for decoding comprising:
decoding first and second bodies of data; and
reusing circuitry associated with decoding the at least first body of data for decoding the at least second body of data.

39. The method of claim 38, further comprising:
combining the first body with the second body of data.

40. The method of claim 38, further comprising:
combining post-clipped data from the first body of data with the second body of data.

41. A method for encoding comprising:
generating at least a first body of data;
generating at least a second body of data, dependent upon the video sequence and a reconstructed portion of the first body of data; and
reusing circuitry associated with generating the at least first body of data for generating the at least second body of data.
